(19) United States
(12) Patent Application Publication
(10) Pub. No.: US 2026/0120190 A1
(43) Pub. Date: Apr. 30, 2026

(54) Systems and Methods for Homeowners Scores

(71) Applicant: STATE FARM MUTUAL AUTOMOBILE INSURANCE COMPANY, Bloomington, IL (US)

(72) Inventors: Laura A. Uphoff, Normal, IL (US); Jason Goldfarb, Bloomington, IL (US); Richa Shrestha, Plano, TX (US); Sean Hickey, Albuquerque, NM (US); Bryan Nussbaum, Edwardsville, IL (US)

(21) Appl. No.: 18/985,435

(22) Filed: Dec. 18, 2024

Related U.S. Application Data
(60) Provisional application No. 63/713,752, filed on Oct. 30, 2024.

(51) Int. Cl. G06Q 40/08; G06Q 30/02

(52) U.S. Cl. CPC G06Q 40/08; G06Q 30/0278

(57) ABSTRACT

The following relates generally to generating and/or displaying a behavioral homeowners score for a property. In some embodiments, one or more processors: (1) set a behavioral homeowners score to an initial value; (2) receive behavioral data, wherein the behavioral data includes an indication of a: (i) completion of a recommendation, and/or (ii) response to an alert associated with the property; (3) update the behavioral homeowners score based upon the behavioral data; and/or (4) display the updated behavioral homeowners score on a display device.

### CROSS REFERENCE TO RELATED APPLICATIONS

This application claims the benefit of U.S. Provisional Application No. 63/713,752, entitled “Systems and Methods for Homeowners Scores” (filed Oct. 30, 2024), the entirety of which is incorporated by reference herein.

### FIELD

The present disclosure generally relates to generating and/or displaying a behavioral homeowners score for a property.

### BACKGROUND

Determining and presenting a home score (e.g., a score rating a home, etc.) may be important to an insurance company. For example, when an insurance customer's home has a high home score, the insurance company may offer the customer a discount on homeowners insurance. However, present systems for determining home scores may have certain drawbacks, such as not properly accounting for a homeowner's behavior.

The systems and methods disclosed herein may provide solutions to these problems and may provide solutions to the ineffectiveness, insecurities, difficulties, inefficiencies, encumbrances, and/or other drawbacks of conventional techniques.

### SUMMARY

Generally speaking, an app may generate a behavioral homeowners score for a home based upon how homeowner(s) interact with their home. To this end, in some examples, the app may generate a recommendation for the property (e.g., a recommendation for how to improve the property, sometimes referred to as an “insight”), and the behavioral homeowners score may be increased when the recommendation is completed. Additionally or alternatively, responses to emergency alerts may also be used to modify the behavioral homeowners score. The behavioral homeowner score may be different than a nonbehavioral home score (e.g., a score based upon nonbehavioral attributes, such as fire protection attributes, weather hazard attributes, home location, etc.)

In one aspect, a computer-implemented method for generating and/or displaying a behavioral homeowners score for a property may be provided. The method may be implemented via one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components, which may be in wired or wireless communication with one another. For instance, in one example, the method may include: (1) setting, via one or more processors, the behavioral homeowners score to an initial value; (2) receiving, via the one or more processors, behavioral data, wherein the behavioral data includes an indication of a: (i) completion of a recommendation, and/or (ii) response to an alert associated with the property; (3) updating, via the one or more processors, the behavioral homeowners score based upon the behavioral data; and/or (4) displaying, via the one or more processors, the updated behavioral homeowners score on a display device. The method may include additional, fewer, or alternate actions, including those discussed elsewhere herein.

In another aspect, a computer device configured for generating and/or displaying a behavioral homeowners score for a property may be provided. The computer device may include one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components, which may be in wired or wireless communication with one another. For example, in one instance, the computer device may include one or more processors configured to: (1) set the behavioral homeowners score to an initial value; (2) receive behavioral data, wherein the behavioral data includes an indication of a: (i) completion of a recommendation, and/or (ii) response to an alert associated with the property; (3) update the behavioral homeowners score based upon the behavioral data; and/or (4) display the updated behavioral homeowners score on a display device. The computer device may include additional, less, or alternate functionality, including that discussed elsewhere herein.

In yet another aspect, a computer system configured for generating and/or displaying a behavioral homeowners score for a property may be provided. The computer system may include one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components. For instance, in one example, the computer system may include: one or more processors; and/or one or more non-transitory memories coupled to the one or more processors. The one or more non-transitory memories may include computer-executable instructions stored therein that, when executed by the one or more processors, may cause the one or more processors to: (1) set the behavioral homeowners score to an initial value; (2) receive behavioral data, wherein the behavioral data includes an indication of a: (i) completion of a recommendation, and/or (ii) response to an alert associated with the property; (3) update the behavioral homeowners score based upon the behavioral data; and/or (4) display the updated behavioral homeowners score on a display device. The computer system may include additional, less, or alternate functionality, including that discussed elsewhere herein.

### BRIEF DESCRIPTION OF THE DRAWINGS

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 depicts an exemplary computer system for generating and/or displaying a behavioral homeowners score for a property.

FIG. 2 depicts an exemplary screen including a behavioral homeowners score.

FIG. 3 depicts an exemplary screen including a nonbehavioral home score.

FIG. 4 depicts an exemplary screen including an overall home score.

FIG. 5 depicts an exemplary flow diagram representing an exemplary computer-implemented method or implementation for generating and/or displaying a behavioral homeowners score.

FIG. 6 depicts an exemplary screen including tutorial explaining how to complete a recommendation to install a smoke detector.

FIG. 7 depicts an exemplary screen including an alert.

FIG. 8 depicts a block diagram of an exemplary machine learning modeling method for training and evaluating exemplary machine learning model(s).

FIG. 9 depicts an exemplary fire protection attribute.

FIG. 10 depicts exemplary matrix of smart smoke detectors indicating points that the smart smoke detectors may increase a subscore by.

FIG. 11 depicts exemplary generative AI training of an exemplary chatbot.

### DETAILED DESCRIPTION

The present embodiments relate to, inter alia, generating and/or displaying a behavioral homeowners score for a property.

Broadly speaking, it may be desirable for an insurance to company to determine a home score (e.g., a score rating a home, etc.). For example, when an insurance customer's home has a high home score, the insurance company may offer the customer a discount on homeowners insurance. However, present systems for determining home scores may have certain drawbacks, such as not properly accounting for a homeowner's behavior.

To address this challenge, embodiments described herein determine a behavioral homeowners score for a property.

### Exemplary Computer System

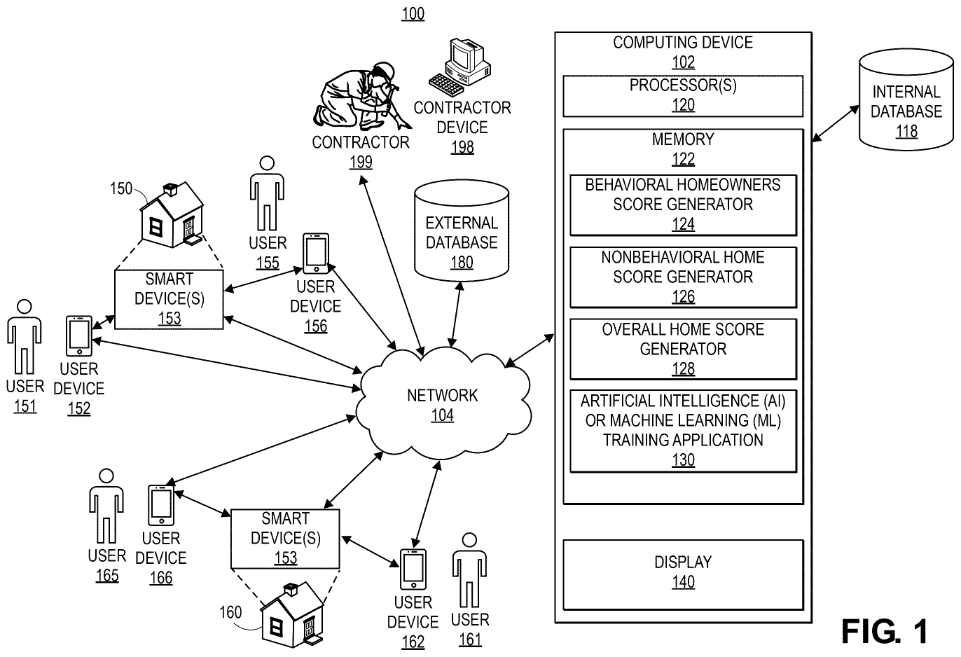

To this end, FIG. 1 illustrates an exemplary computer system 100 for generating and/or displaying a behavioral homeowners score for a property in which the exemplary computer-implemented methods described herein may be implemented. The high-level architecture includes both hardware and software applications, as well as various data communications channels for communicating data between the various hardware and software components.

The computing device 102 may include one or more processors 120 such as one or more microprocessors, controllers, and/or any other suitable type of processor. The computing device 102 may further include a memory 122 (e.g., volatile memory, non-volatile memory) accessible by the one or more processors 120 (e.g., via a memory controller). The one or more processors 120 may interact with the memory 122 to obtain and execute, for example, computer-readable instructions stored in the memory 122. Additionally or alternatively, computer-readable instructions may be stored on one or more removable media (e.g., a compact disc, a digital versatile disc, removable flash memory, etc.) that may be coupled to the computing device 102 to provide access to the computer-readable instructions stored thereon. In particular, the computer-readable instructions stored on the memory 122 may include instructions for executing various applications, such as behavioral homeowners score generator 124, nonbehavioral home score generator 126, overall home score generator 128, and/or artificial intelligence (AI) or machine learning (ML) training application 130. The computing device 102 may further include display 140.

An insurance company that owns the computing device 102 may provide insurance to any of the users 151, 155, 161, 165 for the home 150, 160 (e.g., property), such as homeowners insurance, renters insurance, commercial insurance, umbrella insurance, etc. The users 151, 155, 161, 165 may be, for example, property owners. For example, one or both of the users 151, 155 may be homeowners of home 150; and/or one or both of the users 161, 165 may be homeowners of home 160.

In some examples, the behavioral homeowners score generator 124 may generate a behavioral homeowners score for a property based upon how homeowner(s) interact with their home. For example, an app may generate a recommendation for the property (e.g., a recommendation for how to improve the property, sometimes referred to as an “insight”), and the behavioral homeowners score may be increased when the recommendation is completed. In another example, responses to emergency alerts may also be used to modify the behavioral homeowners score. The behavioral homeowners score may be based upon one user, or more than one user. For example, the behavioral score for home 150 may be based upon one or both of users 151, 155. The generation of the behavioral homeowners score will be described in further detail elsewhere herein.

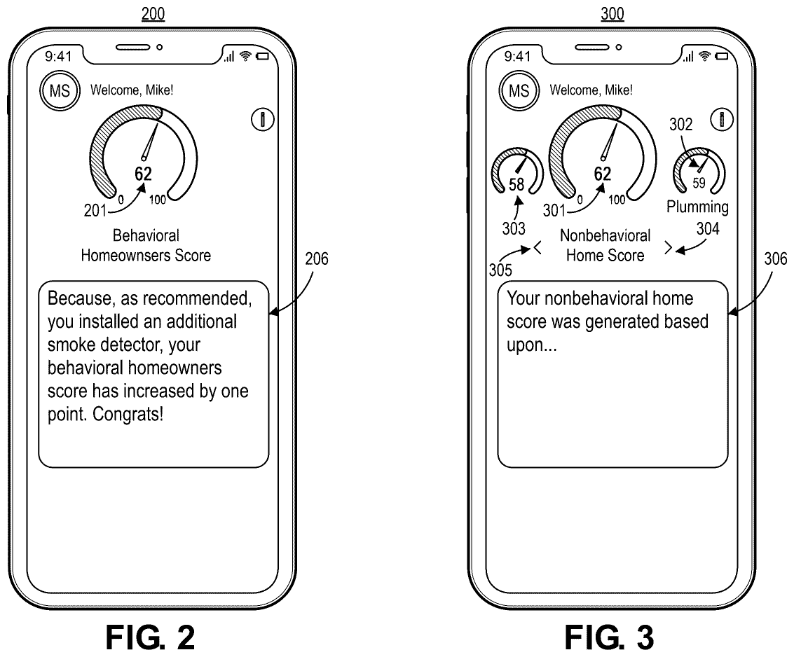

FIG. 2 depicts an exemplary screen 200 (e.g., on a display of any of the user devices 152, 156, 162, 166) illustrating exemplary behavioral homeowners score 201. Exemplary screen 200 further illustrates textbox 206 including an explanation of a change in the behavioral homeowners score.

The behavioral homeowners score may be different than a nonbehavioral home score. In some examples, the nonbehavioral home score is based upon nonbehavioral attributes, such as fire protection attributes, weather hazard attributes, home location, etc. In some examples, the nonbehavioral attributes may be used to determine subscores, such as a safety subscore, a structural subscore, a plumbing subscore, an appliances subscore, a heating, ventilation, and air conditioning (HVAC) subscore, etc. In turn the subscores may be used to determine the nonbehavioral home score. The nonbehavioral home score may be generated by the nonbehavioral home score generator 126. The generation of the nonbehavioral home score will be described in further detail elsewhere herein.

FIG. 3 depicts an exemplary screen 300 (e.g., on a display of any of the user devices 152, 156, 162, 166). Exemplary screen 300 depicts a home's: (i) nonbehavioral home score 301; (ii) plumbing subscore 302; and (iii) safety subscore 303. Arrows 304, 305 allow the user 151 to toggle between subscores (e.g., pressing arrow 305 may show the structural subscore or another subscore, etc.). Text box 306 also includes an explanation of how nonbehavioral home score was generated.

The behavioral homeowners score and/or the nonbehavioral home score may be different than the overall home score. The overall home score may be based upon one or both of the behavioral homeowners score and/or the nonbehavioral home score. In some embodiments, the overall home score is the behavioral homeowners score (e.g., embodiments where there is no nonbehavioral home score). In some embodiments, the overall home score is the nonbehavioral home score (e.g., embodiments where there is no behavioral homeowners score). The overall home score may be generated by the overall home score generator 128.

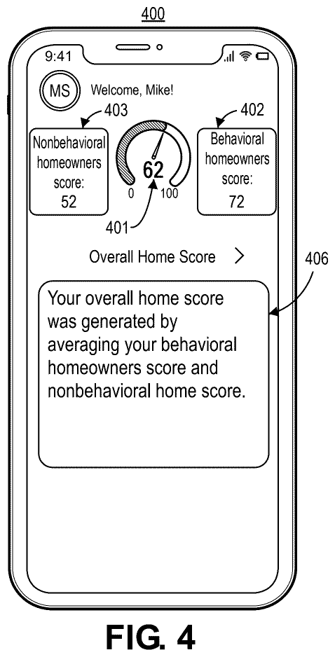

FIG. 4 depicts an exemplary screen 400 (e.g., on a display of any of the user devices 152, 156, 162, 166). Exemplary screen 400 depicts a home's: overall home score 401, behavioral homeowners score 402, and nonbehavioral home score 403. Exemplary screen 400 further depicts text box 406 including an explanation of how the overall home score was generated.

In some embodiments, any or all of the behavioral homeowners score, the nonbehavioral home score and/or the overall home score may be based at least in part upon senor data, such as sensor data gathered from smart device(s) 153, 163.

The AI or ML training application 130 may train any or all of the behavioral homeowners score generator 124, nonbehavioral home score generator 126, and overall home score generator 128. For example, as will be described elsewhere herein, the AI or ML training application 130 may route historical data into an algorithm run by any of these components for training.

The user device 152, 156, 162, 166 may be any suitable device, such as a computer, a mobile device, a smartphone, a laptop, a phablet, a chatbot or voice bot, etc. The device may include one or more display devices, one or more processors, one or more memories, etc.

In addition, contractor 199 may, for example, perform work on the property 150, 160. The contractor 199 may use contractor user device 198, such as a computer, a mobile device, a smartphone, a laptop, a phablet, a chatbot or voice bot, etc.

In addition, further regarding the example system 100, the illustrated exemplary components may be configured to communicate, e.g., via a network 104 (which may be a wired or wireless network, such as the internet), with any other component. Furthermore, although the example system 100 illustrates only certain number(s) of each of the components, any number of the example components are contemplated (e.g., any number of properties/homes, users, user computing devices, smart devices, contractor, contractor computing devices, computing devices, etc.).

### Exemplary Method for Generating And/or Displaying a Behavioral Homeowners Score

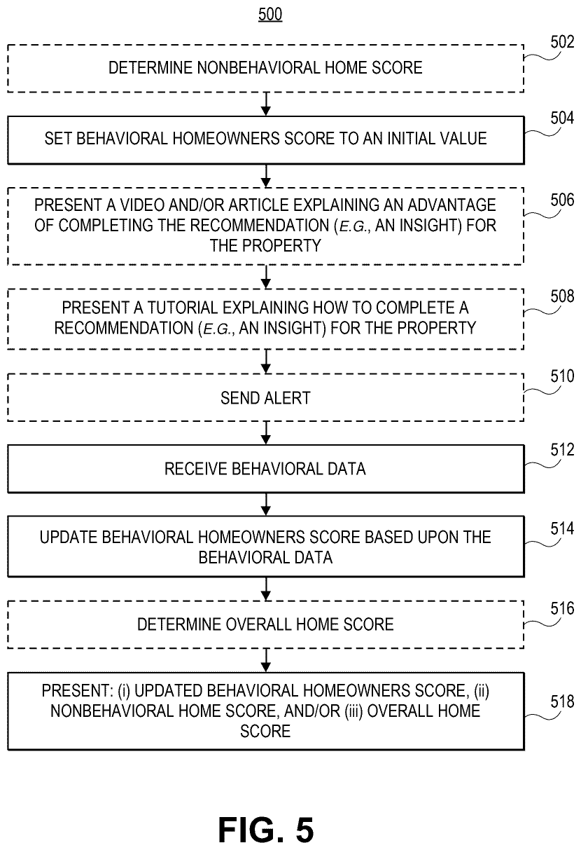

FIG. 5 illustrates an exemplary flow diagram representing an exemplary computer-implemented method or implementation 500 for generating and/or displaying a behavioral homeowners score. The method 500 may be implemented by a computing environment 100, for example, including the computing device 102, properties 150, 160, user devices 152, 156, 162, 166, and/or any suitable device including those discussed elsewhere herein, such as one or more local or remote processors, transceivers, memory units, sensors, mobile devices, unmanned aerial vehicles (e.g., drones), etc.

Although the following discussion may refer to the exemplary method or implementation 500 as being performed by the one or more processors 120, it should be understood that any or all of the blocks may be alternatively or additionally performed by any other suitable component as well (e.g., one or more processors of a user device 152, 156, 162, 166, etc.).

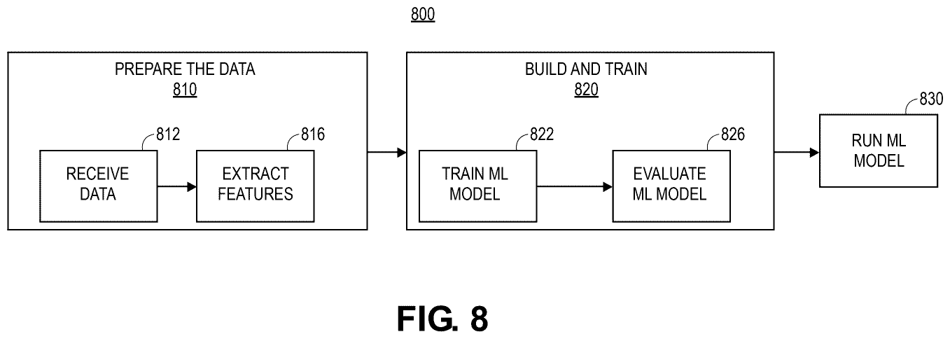

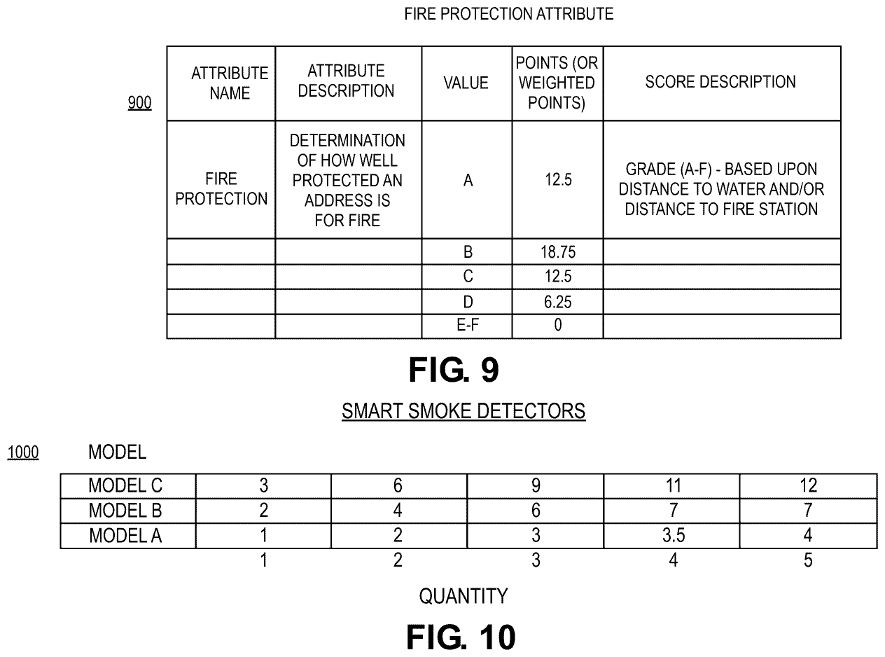

The exemplary computer-implemented method or implementation 500 may begin at optional block 502 when the one or more processors 120 determine a nonbehavioral home score. The determination of the nonbehavioral home score will be described elsewhere herein (e.g., with respect to FIGS. 9-10, etc.). The nonbehavioral home score may be determined with or without the use of AI and/or ML. Examples that use AI and/or ML will be described elsewhere herein, for example, with respect to FIG. 8.

At block 504, the one or more processors 120 may set the behavioral homeowners score to an initial value. In some embodiments, the initial value is the nonbehavioral home score (e.g., determined at block 502). In some embodiments, the initial value is a predetermined value (e.g., 0, 10, 100, a maximum value of the behavioral homeowners score, a minimum value of the behavioral homeowners score, a middle value that is the middle between the maximum and minimum of the behavioral homeowners score, etc.).

The initial value may be determined with or without the use of AI and/or ML. Examples that use AI and/or ML will be described elsewhere herein, for example, with respect to FIG. 8.

At optional block 506, the one or more processors 120 may present a video and/or article explaining one or more advantages of completing a recommendation (e.g., insight). Additionally or alternatively, the video and/or article may explain one or more disadvantages of not completing the recommendation.

In some examples, the recommendation is for the property (e.g., a recommendation that will improve the property). Some examples of such recommendations include: changing a heating, venting, and cooling (HVAC) filter; performing water heater maintenance; cleaning faucets and/or showerheads to remove mineral deposits; checking toilets for running water and/or leaks around seal at base; inspecting and/or cleaning dryer vents; searching foundation and/or walls for water leaks or damage; installing outside lighting; etc.

In some examples, the recommendation is a recommendation for the user 151, 155, 161, 165 to learn a skill. Examples of the skill include: locating a water main valve and learning how to shut off the water main valve; checking a smoke detector battery; locating gas main and learning how to shut off the gas main; locating a circuit breaker box; and/or searching foundation and/or walls for water leaks or damage.

The video and/or article may be presented in response to the one or more processors 120 receiving a selection (e.g., from the user device 152, 156, 162, 166, etc.) to be presented with the article and/or video. The article and/or video may be presented via a display and/or speakers of the user device 152, 156, 162, 166, etc.

In one example, the recommendation comprises a recommendation to install outside lighting; and the video and/or article explains that houses with outside lighting are less likely to be broken in to and/or vandalized.

In another example, the recommendation comprises a recommendation to install an additional smoke alarm; and the video and/or article explains that the additional smoke alarm will reduce the likelihood of the user 151, 155, 161, 165 having to place an insurance claim for fire damage.

In some examples, a recommendation is presented to the user 151, 155, 161, 165 in response to the placement of an insurance claim and/or payment for an insurance claim. For example, following an insurance claim for fire damage, the one or more processors 120 may present a recommendation to install an additional smoke detector.

At optional block 508, the one or more processors 120 may present a tutorial explaining how to complete the recommendation for the property. The tutorial may be presented in response to the one or more processors 120 receiving a selection (e.g., from the user device 152, 156, 162, 166, etc.) to be presented with the tutorial. The tutorial may be presented via a display and/or speakers of the user device 152, 156, 162, 166, etc.

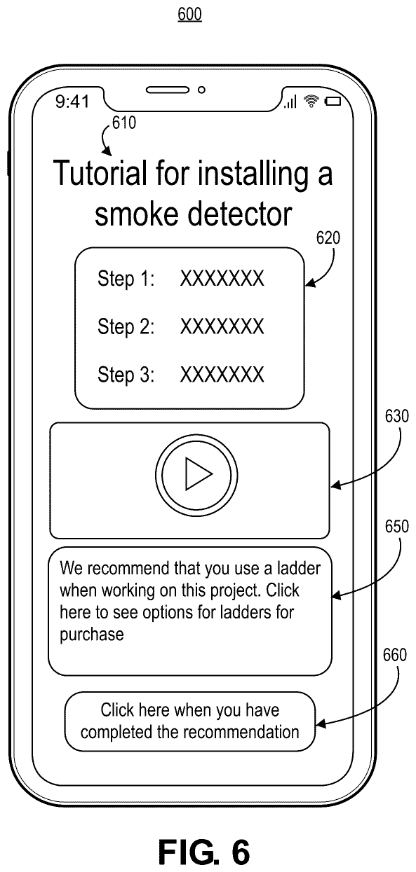

FIG. 6 depicts an exemplary screen 600 including tutorial 610 explaining how to complete a recommendation to install a smoke detector. The tutorial 610 may be presented via a display and/or speakers of the user device 152, 156, 162, 166, etc. The exemplary tutorial 610 includes both text 620 and video 630. The exemplary tutorial 610 may further include recommendation for a tool 650 to use while completing the recommendation. Button 660 may also be displayed allowing the user 151, 155, 161, 165 to indicate completion of the recommendation.

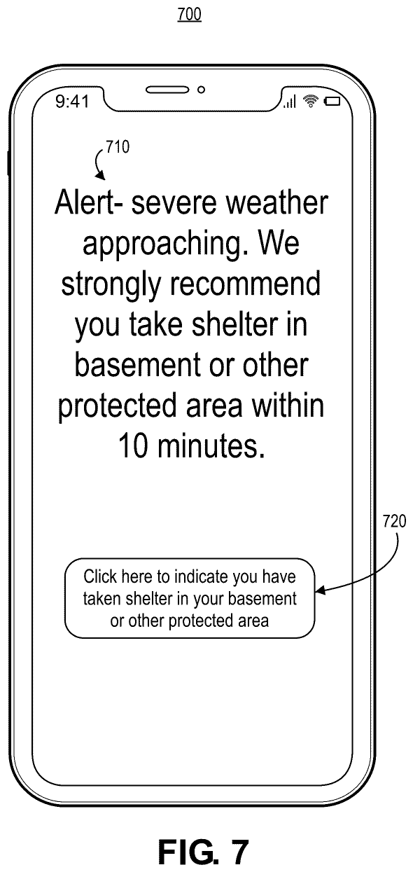

At optional block 510, the one or more processors 120 may send an alert. The alert may be presented via a display and/or speakers of the user device 152, 156, 162, 166, etc. FIG. 7 depicts exemplary screen 700 with alert 710. The alert 710 is a severe weather alert and includes a recommendation to take shelter. The illustrated example further includes button 720 allowing the user 151, 155, 161, 165 to indicate that she has taken shelter.

At block 512, the one or more processors 120 may receive behavioral data. Some examples of the behavioral data include an indication of a: (i) completion of the recommendation (e.g., entered via button 660), and/or (ii) response to an alert associated with the property (e.g., entered via button 720).

The behavioral data may be received in real-time (e.g., once the user presses button 660, the indication is sent immediately to the one or more processors 120), or periodically (e.g., one an hour, once a day, once a week, etc.). Periodic sending of the behavioral data allows data to be grouped together and transmitted together (e.g., two indications of completed recommendations grouped together). Advantageously, this improves technical functioning. For example, because less transmissions are made, power and bandwidth are saved.

Moreover, in some examples, the behavioral homeowners score is based upon more than one homeowner. For example, if, in a periodic transmission, behavioral data is received from both user 151 (e.g., via user device 152), and user 155 (e.g., via user device 156), then the update may be based upon the behavioral data received from both users 151, 155.

At block 514, the one or more processors 120 may update the behavioral homeowners score based upon the behavioral data. In some examples, if the behavioral data indicates completion of a recommendation, the behavioral homeowners score is increased. In some examples, if the behavioral data indicates that an alert has been responded to, the behavioral homeowners score is increased.

The behavioral data may be received from any suitable source, such as the user device 151, 156, 161, 166, the smart device(s) 153, 163, the contractor device 198, etc. In some examples, the behavioral data includes imagery data (e.g., images, videos, etc.). For example, if the alert indicates to take shelter in the basement or other protected area (as in the example of FIG. 7), a smart device 153 (e.g., including a camera, etc.) may send imagery data to the computing device 102, which may determine that the user 151 has entered the basement or other protected area, thus responding to the alert. Additionally or alternatively, in this example, the smart device 153 itself may detect that the user 151 has entered the basement or other protected area, and send an indication of the detection (as the behavioral data) to the one or more processors 120.

In another example, the contractor 199 completes a recommendation for the home 150, and sends an indication of the completion (e.g., as the behavioral data) to the one or more processors 120 via the contractor device 198.

In yet another example, the alert is an alert that a hailstorm is approaching, and the behavioral data indicates that the user 151 has moved a vehicle into a garage or other safe location.

In some examples, the behavioral homeowners score is updated by a predetermined amount (e.g., dependent upon a type of recommendation completed and/or a type of alert responded to). For example, in response to the behavioral data indicating completion of installing an additional smoke detector, the behavioral homeowners score may be increased by one point. In another example, in response to a severe weather alert, a user 151 taking shelter in her basement may increase the behavioral homeowners score by two points.

The update to the behavioral homeowners score may be determined with or without the use of AI and/or ML. Examples that use AI and/or ML will be described elsewhere herein, for example, with respect to FIG. 8.

At optional block 516, the one or more processors 120 may determine an overall home score. The overall home score may be based upon one or both of the behavioral homeowners score and/or the nonbehavioral home score. In some embodiments, the overall home score is the behavioral homeowners score (e.g., embodiments where there is no nonbehavioral home score). In some embodiments, the overall home score is the nonbehavioral home score (e.g., embodiments where there is no behavioral homeowners score). In some embodiments, the overall home score is an average or weighted average of the behavioral homeowners score and nonbehavioral home score (e.g., with the behavioral homeowners score weighted higher or lower than the nonbehavioral home score).

The overall home score may be determined with or without the use of AI and/or ML. Examples that use AI and/or ML will be described elsewhere herein, for example, with respect to FIG. 8.

At block 518, the (i) updated behavioral homeowners score, (ii) nonbehavioral home score, and/or (iii) overall home score may be presented. The presentation may be made in visual and/or auditory form. For example, there may be a display (e.g., at a display of a display of any user device 151, 156, 161, 166). Additionally or alternatively, any of the scores may be presented in auditory form (e.g., via a speaker of any user device 151, 156, 161, 166). FIGS. 2-4 depict illustrative examples.

It should be understood that not all blocks and/or events of the exemplary signal diagrams and/or flowcharts are required to be performed. Moreover, the exemplary signal diagrams and/or flowcharts are not mutually exclusive (e.g., block(s)/events from each example signal diagram and/or flowchart may be performed in any other signal diagram and/or flowchart). The exemplary signal diagrams and/or flowcharts may include additional, less, or alternate functionality, including that discussed elsewhere herein.

### Exemplary AI And/or ML Techniques For Determining a Behavioral Homeowners Score

In some embodiments, AI and/or ML algorithm(s) and/or model(s) may be used to partially or wholly determine: (i) behavioral homeowners scores (e.g., including the initial value of block 504, the update of block 514, etc.), and/or (ii) nonbehavioral home scores (e.g., determined at block 502, etc.). Although the following discussion refers to an ML algorithm, it should be appreciated that it applies equally to ML and/or AI algorithms and/or models.

FIG. 8 is a block diagram of an exemplary machine learning modeling method 800 for training and evaluating a ML algorithm (e.g., a behavioral homeowners score determining ML algorithm, a nonbehavioral home score determining ML algorithm, etc.), in accordance with various embodiments. In some embodiments, the model “learns” an algorithm capable of performing the desired function, such as determining a behavioral homeowners score. It should be understood that the principles of FIG. 8 may apply to any machine learning algorithm discussed herein.

Although the following discussion refers to the blocks of FIG. 8 as being performed by the one or more processors 120, it should be appreciated that the blocks of FIG. 8 may be performed by any suitable component or combinations of components (e.g., one or more processors of any of the user devices 152, 156, 162, 166, etc.).

At a high level, the machine learning modeling method 800 includes a block 810 to prepare the data, a block 820 to build and train the model, and a block 830 to run the model.

Block 810 may include sub-blocks 812 and 816. At block 812, the one or more processors 120 may receive the historical information to train the machine learning algorithm. In some examples, the historical information comprises: (i) inputs to the machine learning model (e.g., also referred to as independent variables, or explanatory variables), and/or (ii) outputs of the machine learning model (e.g., also referred to as dependent variables, or response variables).

In some such examples, the dependent variables are the outputs that the ML algorithm is trained to determine; and the independent variables are used to determine the dependent variables. Put another way, the independent variables may have an impact on the dependent variables; and the ML algorithms may be trained to find this impact. Therefore, when using a trained ML algorithm to determine an output, information corresponding to the historical information that the ML was trained on may be routed into the ML algorithm to determine the initial value or an update to the behavioral homeowners score, or determine the nonbehavioral home score. For example, indications of completions of recommendations, indications of responses to alerts, data from smart devices, and/or data from user devices may be input into the ML algorithm to determine an update to a behavioral homeowners score.

To further elaborate, for the historical information used to train a behavioral homeowners score determining ML algorithm, examples of the historical information include independent variables including historical: indications of completions of recommendations (and/or including the types of completed recommendations), indications of responses to alerts (and/or including the types of responded to alerts), data from smart devices, and/or data from user devices. Further examples of the historical information include dependent variables including: initial values of behavioral homeowners scores, and/or updates to behavioral homeowners scores.

To determine the nonbehavioral home score, some embodiments first determine subscores, and then use the subscores to determine the nonbehavioral home score. For example, there may be any or all of a safety subscore, a structural subscore, a plumbing subscore, an appliances subscore, and/or a heating, ventilation, and air conditioning (HVAC) subscore. Each of the subscores may be determined with or without use of ML.

For the historical information used to train a safety subscore machine learning algorithm, examples of the historical information include historical: (i) independent variables comprising (a) historical fire protection attributes, (b) historical weather hazard attributes, (c) historical tree overhang attributes, and/or (d) other hazard attributes; and/or (ii) dependent variables comprising historical safety subscores.

For the historical information used to train a structural subscore machine learning algorithm, examples of the historical information include historical: (i) independent variables including: (a) historical structural grades, and/or (b) historical home ages, and/or (ii) dependent variables comprising historical structural subscores.

For the historical information used to train a plumbing subscore machine learning algorithm, examples of the historical information include historical: (i) independent variables including: (a) historical plumbing grades, and/or (b) historical dates of most recent plumbing inspections, and/or (ii) dependent variables comprising historical plumbing subscores.

For the historical information used to train an appliances subscore machine learning algorithm, examples of the historical information include historical: (i) independent variables including (a) historical energy grades, (b) historical appliance maintenance grades, and/or (c) historical heating, ventilation, and air conditioning (HVAC) attributes, and/or (ii) dependent variables comprising historical appliances subscores.

For the historical information used to train a HVAC subscore machine learning algorithm, examples of the historical information include historical: (i) independent variables including: (a) historical HVAC grades, and/or (b) historical ages of HVAC units, and/or (ii) dependent variables comprising historical HVAC subscores.

Examples of any of the machine learning algorithms discussed above include: generative AI, deep learning algorithm(s), neural networks, convolutional neural networks, linear regression algorithm(s), logistic regression algorithm(s), decision trees, random forests, support vector machines, k-nearest neighbors, naïve bayes, an ensemble model (e.g., boosting algorithm(s), etc.), hidden Markov models, k-means clustering algorithm(s), and reinforcement learning algorithm(s) (e.g., Q-learning algorithm(s), deep Q-network algorithm(s), etc.), which may be employed individually or in combination with additional machine learning algorithms, including those mentioned herein.

Once the subscores are determined, the nonbehavioral home score may be determined based upon any or all of the subscores. For example, to determine the nonbehavioral home score, the subscores may be added together, or averaged together. In another example, the nonbehavioral home score may be determined by taking a weighted average of the subscores.

The historical information may be received from any suitable source. Examples of sources that any of the historical information may be received from include: memory 122, internal database 118, external database 180, smart devices 153, 163, etc. It should be appreciated that the historical information may be received from combinations of these sources as well.

Block 820 may include sub-blocks 822 and 826. At block 822, the machine learning (ML) model is trained (e.g. based upon the data received from block 810). In some embodiments where associated information is included in the historical information, the ML model “learns” an algorithm capable of calculating or predicting the target feature values (e.g., determining a behavioral homeowners score, a nonbehavioral home score, etc.) given the predictor feature values. The training process of bock 822 may include a supervised, unsupervised, semi-supervised, and/or reinforcement learning process(s). The model may be a deep learning model, a neural network, a convolutional neural network, etc.

At block 826, the one or more processors 120 may evaluate the machine learning model, and determine whether or not the machine learning model is ready for deployment.

Further regarding block 826, evaluating the model sometimes involves testing the model using testing data or validating the model using validation data. Testing/validation data typically includes both predictor feature values and target feature values (e.g., including known inputs and outputs), enabling comparison of target feature values predicted by the model to the actual target feature values, enabling one to evaluate the performance of the model. This testing/validation process is valuable because the model, when implemented, will generate target feature values for future input data that may not be easily checked or validated.

Thus, it is advantageous to check one or more accuracy metrics of the model on data for which the target answer is already known (e.g., testing data or validation data, such as data including historical information, such as the historical information discussed above), and use this assessment as a proxy for predictive accuracy on future data. Exemplary accuracy metrics include key performance indicators, comparisons between historical trends and predictions of results, cross-validation with subject matter experts, comparisons between predicted results and actual results, etc.

Moreover, it should be appreciated the ML algorithm may be any kind of ML algorithm (e.g., neural network, convolutional neural network, deep learning algorithm, etc.).

It should be understood that not all blocks and/or events of the exemplary signal diagrams and/or flowcharts are required to be performed. Moreover, the exemplary signal diagrams and/or flowcharts are not mutually exclusive (e.g., block(s)/events from each example signal diagram and/or flowchart may be performed in any other signal diagram and/or flowchart). The exemplary signal diagrams and/or flowcharts may include additional, less, or alternate functionality, including that discussed elsewhere herein.

### Exemplary Determination of the Nonbehavioral Home Score

As mentioned above, some embodiments may include determining a nonbehavioral home score and/or subscores. Examples of the subscores include a safety subscore (e.g., safety with regard to fire, weather hazards, tree overhang, etc.), a structural subscore, a plumbing subscore, a HVAC subscore, an appliance subscore, etc. Such a determination may be done at block 502 or any other point with respect to the exemplary computer-implemented method 500 of FIG. 5.

The nonbehavioral home score(s) may be determined by any suitable technique. In some examples, the nonbehavioral home scores may be determined without the use of machine learning. For example, in some embodiments, the subscores may be determined by determining attribute(s) for each subscore. Subsequently, the overall nonbehavioral home score may be determined by combining the subscores (e.g., by taking an average or weighted average of the subscores).

For example, in some variations, the home safety subscore may be determined based upon one or more home safety attributes; the structural protection subscore may be determined based upon one or more structural attributes; the plumbing subscore may be determined based upon one or more plumbing attributes; the HVAC subscore may be determined based upon one or more home HVAC attributes; and/or the appliance subscore may be determined based upon one or more appliance attributes.

Any or all of the attributes may be valued (e.g., measured, etc.) in the form of a “grade.” In this regard, such attributes may be “categorical” attributes. In some examples, the grades may be letter grades of A through F. Further, the grades may be assigned numerical scores.

By way of exemplary illustration, FIG. 9 shows an exemplary table 900 indicating information of an exemplary fire protection attribute. The attribute may have a name, which, in the illustrated example, is a fire protection attribute. The exemplary attribute may be assigned a grade (e.g., a value), such as a grade of A through F. The grade/value may further be assigned points and/or weighted points. For instance, in the illustrated example, a grade of A may be assigned 12.5 points; a grade of B may be assigned 9.375 points; a grade of C may be assigned 6.25 points; a grade of D assigned 3.125 points; and/or a grade of E or F assigned 0 points.

In some embodiments, when values are missing (e.g., NaN, etc.), they may be filled in with a neutral value. For instance, with respect to the example of FIG. 9, if any of the values corresponding to attributes with a grade (A-F) are missing, they may be filled in with a value of C. For example, if the value is missing, it may be filled in with a value of C, and thus receive points or weighted points of 6.25.

In some implementations, the grades and/or categorical values may be assigned by a vendor evaluating the home 150. The assigned grades and/or categorical values may then be stored in a database (e.g., internal database 118, external database 180, etc.), and/or sent directly to any other component in FIG. 1.

Additionally or alternatively, individual devices (e.g., as indicated in the profile, etc.) may affect a nonbehavioral home score(s) by a specific amount (e.g., adding a support beam improves the structural subscore by 3 points; adding new furnace improves the HVAC subscore by 4 points; etc.). In addition, in some embodiments, each device affects the nonbehavioral home score incrementally (e.g., each smart smoke detector added adds one point to the safety subscore, etc.). However, in some such embodiments, there is a maximum number of devices that may continue to improve the nonbehavioral home score(s) (e.g., the first 5 smoke detectors each improve the safety subscore by 1 point, but the sixth does not improve the nonbehavioral home score). In some certain embodiments, the improvements are phased out (e.g., the first four smoke detectors each improve the safety subscore by 1 point, the next 3 smoke detectors improve the safety subscore by half a point, and the subsequent smoke detectors do not improve the safety subscore). Furthermore, different models of a device may have different impacts on the nonbehavioral home score(s) (e.g., a basic model smart furnace improves a HVAC subscore by 2 points, and a more advanced model improves the HVAC subscore by 4 points). As such, the nonbehavioral home score may be affected by both the model and the quantity of the device.

To this end, the attribute may also comprise a matrix of devices. For example, for any of the subscores, there may be an attribute including device matrixes for particular devices. For instance, FIG. 10 depicts exemplary matrix 1000 of smart smoke detectors indicating points that the smart smoke detectors increase the safety subscore by. The exemplary matrix 1000 depicts both model and quantity of the device, with the numbers in the matrix indicating how the devices affect the safety subscore. For example, as illustrated, a safety subscore for a home with one model A smoke detector would get 1 point for the model A smoke detector. In another illustrated example, a safety subscore for a home with three model C smoke detectors would get 9 points for the smoke detectors.

Additionally or alternatively, the one or more processors 120 may determine at least one of the subscores via machine learning (e.g., trained as described with respect to FIG. 8).

### Exemplary Training of an Exemplary Chatbot

Advantageously, some aspects include generative AI features. For example, the AI and/or ML training application 130 may train any of the behavioral homeowners score generator 124, the nonbehavioral home score generator 126, and/or overall home score generator 128 to have generative AI features. Such generative AI features may include, for example, a chatbot (e.g., included in any of the behavioral homeowners score generator 124, the nonbehavioral home score generator 126, and/or overall home score generator 128) configured to: (i) converse with any of the users 151, 155, 161, 165, the contractor 199, etc., (ii) generate explanations of how any of the behavioral homeowners score, the behavioral home score, and/or overall home score were generated, and/or (iii) generate the behavioral homeowners score, the behavioral home score, and/or overall home score were generated.

The chatbot may, inter alia, provide tailored, conversational-like services (e.g., answering user 151, 155, 161, 165 questions, etc.). The chatbot may be capable of understanding requests, providing relevant information, escalating issues, etc. Additionally, the chatbot may generate data from interactions which the enterprise may use to personalize future support and/or improve the chatbot's functionality, e.g., when retraining and/or fine-tuning the chatbot. Moreover, although the following discussion may refer to an ML chatbot or an ML model, it should be understood that it applies equally to an AI chatbot or an AI model.

The chatbot may be trained by the AI or ML training application 130 using large training datasets of text which may provide sophisticated capability for natural-language tasks, such as answering questions and/or holding conversations. The chatbot may include a general-purpose pretrained LLM which, when provided with a starting set of words and/or any of the scores discussed herein as an input, may attempt to provide an output (response) of the most likely set of words that follow from the input (e.g., an explanation of the score). In one aspect, the prompt may be provided to, and/or the response received from, the chatbot and/or any other ML model, via display 140, a display of the user device 152, 162, and/or a display of the contractor device 198. This may include a user interface device operably connected via an I/O module. Exemplary user interface devices may include a touchscreen, a keyboard, a mouse, a microphone, a speaker, a display, and/or any other suitable user interface devices.

Multi-turn (i.e., back-and-forth) conversations may require LLMs to maintain context and coherence across multiple user utterances, which may require the chatbot to keep track of an entire conversation history as well as the current state of the conversation. The chatbot may rely on various techniques to engage in conversations with users, which may include the use of short-term and long-term memory. Short-term memory may temporarily store information (e.g., in the memory 122 of the computing device 102) that may be required for immediate use and may keep track of the current state of the conversation and/or to understand the user's latest input in order to generate an appropriate response. Long-term memory may include persistent storage of information (e.g., the internal database 118 of the computing device 102) which may be accessed over an extended period of time. The long-term memory may be used by the chatbot to store information about the user (e.g., preferences, chat history, etc.) and may be useful for improving an overall user experience by enabling the chatbot to personalize and/or provide more informed responses.

In some embodiments, the system and methods to generate and/or train an ML chatbot model (e.g., via the AI or ML training application 130) which may be used in the chatbot, may include three steps: (1) a supervised fine-tuning (SFT) step where a pretrained language model (e.g., an LLM) may be fine-tuned on a relatively small amount of demonstration data curated by human labelers to learn a supervised policy (SFT ML model) which may generate responses/outputs from a selected list of prompts/inputs. The SFT ML model may represent a cursory model for what may be later developed and/or configured as the ML chatbot model; (2) a reward model step where human labelers may rank numerous SFT ML model responses to evaluate the responses which best mimic preferred human responses, thereby generating comparison data. The reward model may be trained on the comparison data; and/or (3) a policy optimization step in which the reward model may further fine-tune and improve the SFT ML model. The outcome of this step may be the ML chatbot model using an optimized policy. In one aspect, step one may take place only once, while steps two and three may be iterated continuously, e.g., more comparison data is collected on the current ML chatbot model, which may be used to optimize/update the reward model and/or further optimize/update the policy.

### Supervised Fine-Tuning ML Model

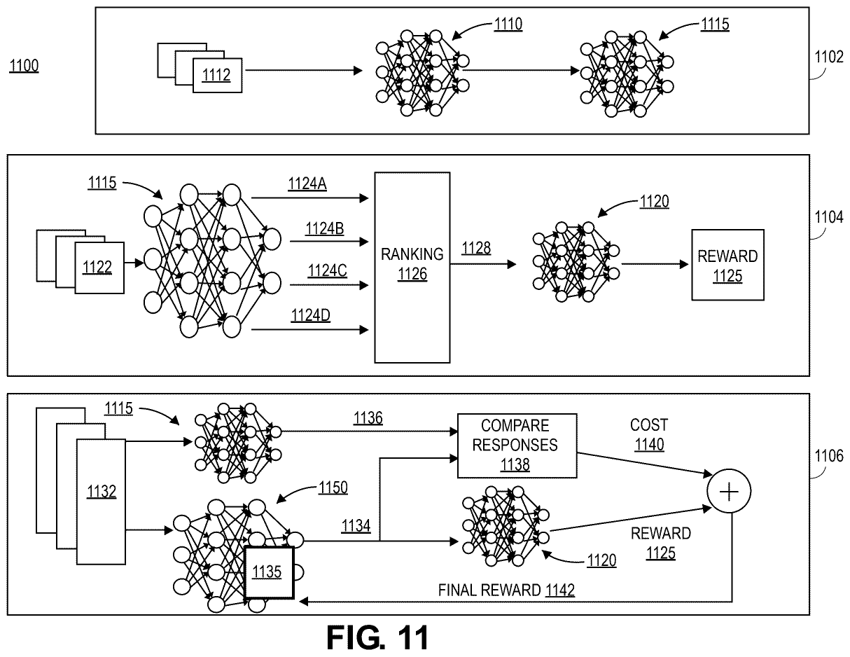

As an initial matter, although the discussion with respect to FIG. 11 refers to ML model 1150, it should be understood that 1150 may refer equally to an AI and/or ML algorithm and/or model.

FIG. 11 depicts a combined block and logic diagram 1100 for training an ML chatbot model, in which the techniques described herein may be implemented, according to some embodiments. It should be understood that FIG. 11 may apply to training any generative AI and/or ML algorithm, and/or chatbot described herein, and FIG. 11 should not be considered to be restricted to the chatbot. In addition, the chatbot may be trained in accordance with any of the other techniques described herein; and the training of the chatbot should not be considered restricted to the teachings of FIG. 11.

Some of the blocks in FIG. 11 may represent hardware and/or software components, other blocks may represent data structures or memory storing these data structures, registers, or state variables (e.g., 1112), and other blocks may represent output data (e.g., 1125). Input and/or output signals may be represented by arrows labeled with corresponding signal names and/or other identifiers. The methods and systems may include one or more blocks 1102, 1104, 1106, which will be described in further detail below. In some embodiments, any or all of the blocks 1102, 1104, 1106 may be servers.

In one aspect, at block 1102, a pretrained language model 1110 may be fine-tuned. The pretrained language model 1110 may be obtained at block 1102 and be stored in a memory, such as memory 122 and/or internal database 118. The pretrained language model 1110 may be loaded into an ML training module at block 1102 for retraining/fine-tuning. A supervised training dataset 1112 may be used to fine-tune the pretrained language model 1110 wherein each data input prompt to the pretrained language model 1110 may have a known output response for the pretrained language model 1110 to learn from. The supervised training dataset 1112 may be stored in a memory at block 1102, e.g., the memory 122 or the internal database 118. In one aspect, the data labelers may create the supervised training dataset 1112 prompts and appropriate responses. The pretrained language model 1110 may be fine-tuned using the supervised training dataset 1112 resulting in the SFT ML model 1115 which may provide appropriate responses to user prompts once trained. The trained SFT ML model 1115 may be stored in a memory, such as the memory 122 or the internal database 118.

In one aspect, the supervised training dataset 1112 may include prompts (e.g., questions about any of the behavioral homeowners score, the behavioral home score and/or overall home score were generated, etc.) and responses (e.g., answers to the questions, explanations of how any of the behavioral homeowners score, the behavioral home score and/or overall home score were generated, etc.) which may be relevant to users 151, 155, 161, 165, etc. In another example, the prompt itself may include the behavioral homeowners score, the behavioral home score, overall home score, and/or behavioral data; and the response may include how the score was generated.

### Training the Reward Model

In one aspect, training the ML chatbot model 1150 may include, at block 1104, training a reward model 1120 to provide as an output a scaler value/reward 1125. The reward model 1120 may be required to leverage Reinforcement Learning with Human Feedback (RLHF) in which a model (e.g., ML chatbot model 1150) learns to produce outputs which maximize its reward 1125, and in doing so may provide responses which are better aligned to user prompts.

Training the reward model 1120 may include, at block 1104, providing a single prompt 1122 to the SFT ML model 1115 as an input. The input prompt 1122 may be provided via an input device (e.g., a keyboard) of the computing device 102. The prompt 1122 may be previously unknown to the SFT ML model 1115, e.g., the labelers may generate new prompt data, the prompt 1122 may include testing data stored on database 118, data source 170, and/or any other suitable prompt data. The SFT ML model 1115 may generate multiple, different output responses 1124A, 1124B, 1124C, 1124D to the single prompt 1122. At block 1104, the computing device 102 (and/or user device 152, 156, 162, 166, etc.) may output the responses 1124A, 1124B, 1124C, 1124D via any suitable technique, such as outputting via a display (e.g., as text responses), a speaker (e.g., as audio/voice responses), etc., for review by the data labelers.

The data labelers may provide feedback (e.g., via the computing device 102, the user device 152, 156, 162, 166, etc.) on the responses 1124A, 1124B, 1124C, 1124D when ranking 1126 them from best to worst based upon the prompt-response pairs. The data labelers may rank 1126 the responses 1124A, 1124B, 1124C, 1124D by labeling the associated data. The ranked prompt-response pairs 1128 may be used to train the reward model 1120. In one aspect, the computing device 102 may load the reward model 1120 via the generative AI training application 128 and train the reward model 1120 using the ranked response pairs 1128 as input. The reward model 1120 may provide as an output the scalar reward 1125.

In one aspect, the scalar reward 1125 may include a value numerically representing a human preference for the best and/or most expected response to a prompt, i.e., a higher scaler reward value may indicate the user is more likely to prefer that response, and a lower scalar reward may indicate that the user is less likely to prefer that response. For example, inputting the “winning” prompt-response (i.e., input-output) pair data to the reward model 1120 may generate a winning reward. Inputting a “losing” prompt-response pair data to the same reward model 1120 may generate a losing reward. The reward model 1120 and/or scalar reward 1136 may be updated based upon labelers ranking 1126 additional prompt-response pairs generated in response to additional prompts 1122.

In one example, a data labeler may provide to the SFT ML model 1115 as an input prompt 1122, “Describe the sky.” The input may be provided by the labeler (e.g., via the computing device 102, etc.) to the computing device 102 running chatbot utilizing the SFT ML model 1115. The SFT ML model 1115 may provide as output responses to the labeler (e.g., via their respective devices): (i) “the sky is above” 1124A; (ii) “the sky includes the atmosphere and may be considered a place between the ground and outer space” 1124B; and (iii) “the sky is heavenly” 1124C. The data labeler may rank 1126, via labeling the prompt-response pairs, prompt-response pair 1122/1124B as the most preferred answer; prompt-response pair 1122/1124A as a less preferred answer; and prompt-response 1122/1124C as the least preferred answer. The labeler may rank 1126 the prompt-response pair data in any suitable manner. The ranked prompt-response pairs 1128 may be provided to the reward model 1120 to generate the scalar reward 1125. It should be appreciated that this facilitates training the chatbot to determine questions corresponding to the various scores discussed herein.

While the reward model 1120 may provide the scalar reward 1125 as an output, the reward model 1120 may not generate a response (e.g., text). Rather, the scalar reward 1125 may be used by a version of the SFT ML model 1115 to generate more accurate responses to prompts, i.e., the SFT model 1115 may generate the response such as text to the prompt, and the reward model 1120 may receive the response to generate a scalar reward 1125 of how well humans perceive it. Reinforcement learning may optimize the SFT model 1115 with respect to the reward model 1120 which may realize the configured ML chatbot model 1150.

### RLHF to Train the ML Chatbot Model

In one aspect, the computing device 102 may train the ML chatbot model 1150 (e.g., via the AI or ML training application 130) to generate a response 1134 to a random, new and/or previously unknown user prompt 1132. To generate the response 1134, the ML chatbot model 1150 may use a policy 1135 (e.g., algorithm) which it learns during training of the reward model 1120, and in doing so may advance from the SFT model 1115 to the ML chatbot model 1150. The policy 1135 may represent a strategy that the ML chatbot model 1150 learns to maximize its reward 1125. As discussed herein, based upon prompt-response pairs, a human labeler may continuously provide feedback to assist in determining how well the ML chatbot's 1150 responses match expected responses to determine rewards 1125. The rewards 1125 may feed back into the ML chatbot model 1150 to evolve the policy 1135. Thus, the policy 1135 may adjust the parameters of the ML chatbot model 1150 based upon the rewards 1125 it receives for generating good responses. The policy 1135 may update as the ML chatbot model 1150 provides responses 1134 to additional prompts 1132.

In one aspect, the response 1134 of the ML chatbot model 1150 using the policy 1135 based upon the reward 1125 may be compared using a cost function 1138 to the SFT ML model 1115 (which may not use a policy) response 1136 of the same prompt 1132. The server 1106 may compute a cost 1140 based upon the cost function 1138 of the responses 1134, 1136. The cost 1140 may reduce the distance between the responses 1134, 1136, i.e., a statistical distance measuring how one probability distribution is different from a second, in one aspect the response 1134 of the ML chatbot model 1150 versus the response 1136 of the SFT model 1115. Using the cost 1140 to reduce the distance between the responses 1134, 1136 may avoid a server over-optimizing the reward model 1120 and deviating too drastically from the human-intended/preferred response. Without the cost 1140, the ML chatbot model 1150 optimizations may result in generating responses 1134 which are unreasonable but may still result in the reward model 1120 outputting a high reward 1125.

In one aspect, the responses 1134 of the ML chatbot model 1150 using the current policy 1135 may be passed by the server 1106 to the rewards model 1120, which may return the scalar reward or discount 1125. The ML chatbot model 1150 response 1134 may be compared via cost function 1138 to the SFT ML model 1115 response 1136 by the server 1106 to compute the cost 1140. The server 1106 may generate a final reward 1142 which may include the scalar reward 1125 offset and/or restricted by the cost 1140. The final reward or discount 1142 may be provided by the server 1106 to the ML chatbot model 1150 and may update the policy 1135, which in turn may improve the functionality of the ML chatbot model 1150.

To optimize the ML chatbot model 1150 over time, RLHF via the human labeler feedback may continue ranking 1126 responses of the ML chatbot model 1150 versus outputs of earlier/other versions of the SFT ML model 1115, i.e., providing positive or negative rewards 1125. The RLHF may allow the AI or ML training application 130 to continue iteratively update the reward model 1120 and/or the policy 1135. As a result, the ML chatbot model 1150 may be retrained and/or fine-tuned based upon the human feedback via the RLHF process, and throughout continuing conversations may become increasingly efficient.

Although multiple blocks 1102, 1104, 1106 are depicted in the exemplary block and logic diagram 1100, each providing one of the three steps of the overall ML chatbot model 1150 training, fewer and/or additional blocks/servers may be utilized and/or may provide the one or more steps of the generative AI training. In one aspect, one server may provide the entire ML chatbot model 1150 training.

### Additional Exemplary Machine Learning Aspects

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors), and/or via computer-executable instructions stored on non-transitory computer-readable media or medium.

In some embodiments, the server computing device is configured to implement machine learning, such that server computing device “learns” to analyze, organize, and/or process data without being explicitly programmed. Machine learning may be implemented through machine learning methods and algorithms (“ML methods and algorithms”). In an exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to images. ML outputs may include, but are not limited to identified objects, items classifications, and/or other data extracted from the images. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of home attributes with known characteristics or features. Such information may include, for example, information associated with a plurality of IoT devices.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments, and may the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text or textual output, visual or graphical output, output for use with speakers and/or display screens, and/or other types of output for user and/or other computer or bot consumption.

Based upon these analyses, the processing element may learn how to identify characteristics and patterns that may then be applied to analyzing and classifying objects. The processing element may also learn how to identify attributes of different objects in different lighting. This information may be used to determine which classification models to use and which classifications to provide.

### Additional Exemplary Embodiments

In one aspect, a computer-implemented method for generating and/or displaying a behavioral homeowners score for a property may be provided. The method may be implemented via one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components, which may be in wired or wireless communication with one another. For instance, in one example, the method may include: (1) setting, via one or more processors, the behavioral homeowners score to an initial value; (2) receiving, via the one or more processors, behavioral data, wherein the behavioral data includes an indication of a: (i) completion of a recommendation, and/or (ii) response to an alert associated with the property; (3) updating, via the one or more processors, the behavioral homeowners score based upon the behavioral data; and/or (4) displaying, via the one or more processors, the updated behavioral homeowners score on a display device. The method may include additional, fewer, or alternate actions, including those discussed elsewhere herein.

In some embodiments, the behavioral data may include the indication of the completion of the recommendation, and/or the recommendation is a recommendation for the property including: (i) changing a heating, venting, and cooling (HVAC) filter; (ii) performing water heater maintenance; (iii) cleaning faucets and/or showerheads to remove mineral deposits; (iv) checking toilets for running water and/or leaks around seal at base; (v) inspecting and/or cleaning dryer vents; (vi) searching foundation and/or walls for water leaks or damage; and/or (vii) installing outside lighting.

In certain embodiments, the behavioral data may include the indication of the completion of the recommendation, and/or the recommendation is a recommendation for the at least one homeowner to learn a skill including: (i) locating a water main valve and/or learning how to shut off the water main valve; (ii) checking a smoke detector battery; (iii) locating a gas main and/or learning how to shut off the gas main; (iv) locating a circuit breaker box; and/or (v) searching foundation and/or walls for water leaks or damage.

In various embodiments, the behavioral data includes the indication of the response to an alert associated with the property; the alert associated with the property includes a weather alert; and/or the response to the alert includes the at least one homeowner moving to a protected area.

In some embodiments, the initial value is a predetermined value.

In certain embodiments, the initial value is a nonbehavioral home score.

In various embodiments, the nonbehavioral home score is determined based upon: (i) a safety subscore, (ii) a structural subscore, (iii) a plumbing subscore, and/or (iv) an appliances subscore.

In some embodiments, the computer-implemented method may further include determining, via the one or more processors, a nonbehavioral home score; and/or determining, via the one or more processors, an overall home score based upon the behavioral homeowners score and/or the nonbehavioral home score.

In certain embodiments, the computer-implemented method may further include presenting, via the one or more processors: a video and/or article explaining an advantage of completing the recommendation for the property; and/or a tutorial explaining how to complete the recommendation for the property.

In another aspect, a computer device configured for generating and/or displaying a behavioral homeowners score for a property may be provided. The computer device may include one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components, which may be in wired or wireless communication with one another. For example, in one instance, the computer device may include one or more processors configured to: (1) set the behavioral homeowners score to an initial value; (2) receive behavioral data, wherein the behavioral data includes an indication of a: (i) completion of a recommendation, and/or (ii) response to an alert associated with the property; (3) update the behavioral homeowners score based upon the behavioral data; and/or (4) display the updated behavioral homeowners score on a display device. The computer device may include additional, less, or alternate functionality, including that discussed elsewhere herein.

In some embodiments, the behavioral data may include the indication of the completion of the recommendation, and/or the recommendation is a recommendation for the property including: (i) changing a heating, venting, and cooling (HVAC) filter; (ii) performing water heater maintenance; (iii) cleaning faucets and/or showerheads to remove mineral deposits; (iv) checking toilets for running water and/or leaks around seal at base; (v) inspecting and/or cleaning dryer vents; (vi) searching foundation and/or walls for water leaks or damage; and/or (vii) installing outside lighting.

In certain embodiments, the behavioral data may include the indication of the completion of the recommendation, and/or the recommendation is a recommendation for at least one homeowner to learn a skill including: (i) locating a water main valve and/or learning how to shut off the water main valve; (ii) checking a smoke detector battery; (iii) locating a gas main and/or learning how to shut off the gas main; (iv) locating a circuit breaker box; and/or (v) searching foundation and/or walls for water leaks or damage.

In various embodiments, the initial value is a predetermined value.

In some embodiments, the one or more processors may be further configured to: determine a nonbehavioral home score; and/or determine an overall home score based upon the behavioral homeowners score and/or the nonbehavioral home score.

In yet another aspect, a computer system configured for generating and/or displaying a behavioral homeowners score for a property may be provided. The computer system may include one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components. For instance, in one example, the computer system may include: one or more processors; and/or one or more non-transitory memories coupled to the one or more processors. The one or more non-transitory memories may include computer-executable instructions stored therein that, when executed by the one or more processors, may cause the one or more processors to: (1) set the behavioral homeowners score to an initial value; (2) receive behavioral data, wherein the behavioral data includes an indication of a: (i) completion of a recommendation, and/or (ii) response to an alert associated with the property; (3) update the behavioral homeowners score based upon the behavioral data; and/or (4) display the updated behavioral homeowners score on a display device. The computer system may include additional, less, or alternate functionality, including that discussed elsewhere herein.

In some embodiments, the behavioral data may include the indication of the completion of the recommendation, and/or the recommendation is a recommendation for the property including: (i) changing a heating, venting, and cooling (HVAC) filter; (ii) performing water heater maintenance; (iii) cleaning faucets and/or showerheads to remove mineral deposits; (iv) checking toilets for running water and/or leaks around seal at base; (v) inspecting and/or cleaning dryer vents; (vi) searching foundation and/or walls for water leaks or damage; and/or (vii) installing outside lighting.

In certain embodiments, the behavioral data may include the indication of the completion of the recommendation, and/or the recommendation is a recommendation for at least one homeowner to learn a skill including: (i) locating a water main valve and/or learning how to shut off the water main valve; (ii) checking a smoke detector battery; (iii) locating a gas main and/or learning how to shut off the gas main; (iv) locating a circuit breaker box; and/or (v) searching foundation and/or walls for water leaks or damage.

In various embodiments, the initial value is a predetermined value.

In some embodiments, the one or more non-transitory memories having stored thereon computer-executable instructions that, when executed by the one or more processors, may cause the one or more processors to: determine a nonbehavioral home score; and/or determine an overall home score based upon the behavioral homeowners score and/or the nonbehavioral home score.

In certain embodiments, the system may further include a user device including the display device.

### Other Matters

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘_______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component.

Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Furthermore, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed:

1. A computer-implemented method for generating and/or displaying a behavioral homeowners score for a property, the property being associated with at least one homeowner, the computer-implemented method comprising:
setting, via one or more processors, the behavioral homeowners score to an initial value;
receiving, via the one or more processors, behavioral data, wherein the behavioral data includes an indication of a: (i) completion of a recommendation, and/or (ii) response to an alert associated with the property;
updating, via the one or more processors, the behavioral homeowners score based upon the behavioral data; and
displaying, via the one or more processors, the updated behavioral homeowners score on a display device.

2. The computer-implemented method of claim 1, wherein the behavioral data includes the indication of the completion of the recommendation, and the recommendation is a recommendation for the property including:
changing a heating, venting, and cooling (HVAC) filter;
performing water heater maintenance;
cleaning faucets and/or showerheads to remove mineral deposits;
checking toilets for running water and/or leaks around seal at base;
inspecting and/or cleaning dryer vents;
searching foundation and/or walls for water leaks or damage; and/or
installing outside lighting.

3. The computer-implemented method of claim 1, wherein the behavioral data includes the indication of the completion of the recommendation, and the recommendation is a recommendation for the at least one homeowner to learn a skill including:
locating a water main valve and learning how to shut off the water main valve;
checking a smoke detector battery;
locating a gas main and learning how to shut off the gas main;
locating a circuit breaker box; and/or
searching foundation and/or walls for water leaks or damage.

4. The computer-implemented method of claim 1, wherein:
the behavioral data includes the indication of the response to an alert associated with the property;
the alert associated with the property includes a weather alert; and
the response to the alert includes the at least one homeowner moving to a protected area.

5. The computer-implemented method of claim 1, wherein the initial value is a predetermined value.

6. The computer-implemented method of claim 1, wherein the initial value is a nonbehavioral home score.

7. The computer-implemented method of claim 6, wherein the nonbehavioral home score is determined based upon: (i) a safety subscore, (ii) a structural subscore, (iii) a plumbing subscore, and/or (iv) an appliances subscore.

8. The computer-implemented method of claim 1, further including:
determining, via the one or more processors, a nonbehavioral home score; and
determining, via the one or more processors, an overall home score based upon the behavioral homeowners score and the nonbehavioral home score.

9. The computer-implemented method of claim 1, further including presenting, via the one or more processors:
a video and/or article explaining an advantage of completing the recommendation; and/or
a tutorial explaining how to complete the recommendation.

10. A computer device for generating and/or displaying a behavioral homeowners score for a property, the computer device comprising one or more processors configured to:
set the behavioral homeowners score to an initial value;
receive behavioral data, wherein the behavioral data includes an indication of a: (i) completion of a recommendation, and/or (ii) response to an alert associated with the property;
update the behavioral homeowners score based upon the behavioral data; and
display the updated behavioral homeowners score on a display device.

11. The computer device of claim 10, wherein the behavioral data includes the indication of the completion of the recommendation, and the recommendation is a recommendation for the property including:
changing a heating, venting, and cooling (HVAC) filter;
performing water heater maintenance;
cleaning faucets and/or showerheads to remove mineral deposits;
checking toilets for running water and/or leaks around seal at base;
inspecting and/or cleaning dryer vents;
searching foundation and/or walls for water leaks or damage; and/or
installing outside lighting.

12. The computer device of claim 10, wherein the behavioral data includes the indication of the completion of the recommendation, and the recommendation is a recommendation for at least one homeowner to learn a skill including:
locating a water main valve and learning how to shut off the water main valve;
checking a smoke detector battery;
locating a gas main and learning how to shut off the gas main;
locating a circuit breaker box; and/or
searching foundation and/or walls for water leaks or damage.

13. The computer device of claim 10, wherein the initial value is a predetermined value.

14. The computer device of claim 10, wherein the one or more processors are further configured to:
determine a nonbehavioral home score; and
determine an overall home score based upon the behavioral homeowners score and the nonbehavioral home score.

15. A computer system for generating and/or displaying a behavioral homeowners score for a property, the computer system comprising:
one or more processors; and
one or more non-transitory memories, the one or more non-transitory memories having stored thereon computer-executable instructions that, when executed by the one or more processors, cause the one or more processors to:
set the behavioral homeowners score to an initial value;
receive behavioral data, wherein the behavioral data includes an indication of a: (i) completion of a recommendation, and/or (ii) response to an alert associated with the property;
update the behavioral homeowners score based upon the behavioral data; and
display the updated behavioral homeowners score on a display device.

16. The computer system of claim 15, wherein the behavioral data includes the indication of the completion of the recommendation, and the recommendation is a recommendation for the property including:
changing a heating, venting, and cooling (HVAC) filter;
performing water heater maintenance;
cleaning faucets and/or showerheads to remove mineral deposits;
checking toilets for running water and/or leaks around seal at base;
inspecting and/or cleaning dryer vents;
searching foundation and/or walls for water leaks or damage; and/or
installing outside lighting.

17. The computer system of claim 15, wherein the behavioral data includes the indication of the completion of the recommendation, and the recommendation is a recommendation for at least one homeowner to learn a skill including:
locating a water main valve and learning how to shut off the water main valve;
checking a smoke detector battery;
locating a gas main and learning how to shut off the gas main;
locating a circuit breaker box; and/or
searching foundation and/or walls for water leaks or damage.

18. The computer system of claim 15, wherein the initial value is a predetermined value.

19. The computer system of claim 15, the one or more non-transitory memories having stored thereon computer-executable instructions that, when executed by the one or more processors, cause the one or more processors to:
determine a nonbehavioral home score; and
determine an overall home score based upon the behavioral homeowners score and the nonbehavioral home score.

20. The computer system of claim 15, further comprising a user device including the display device.
